(19) United States
(12) Patent Application Publication
(10) Pub. No.: US 2004/0065699 A1
(43) Pub. Date: Apr. 8, 2004

(54) Bulk material dispenser

(76) Inventors: Jeffrey R. Schoer, Wabasso, MN (US); Eldo R. Schoer JR., Wabasso, MN (US); Bradley L. Schoer, Walnut Grove, MN (US)

Correspondence Address: Angenehm Law Firm. Ltd., P.O. Box 48755, Coon Rapids, MN, 55448-0755, US

(21) Appl. No.: 10/624,047

(22) Filed: Jul. 21, 2003

Related U.S. Application Data
(60) Provisional application No. 60/398,032, filed on Jul. 23, 2002.

(51) Int. Cl. A01C 1/00

(52) U.S. Cl. 222/608

(57) ABSTRACT

A bulk dispenser, including a frame including legs interconnected with a front rail, rear rail, a right side rail and a left side rail, the rear rail joined to an alignment wedge and at least one back lock down lip; a trolley joined to material moving device and joined to the frame, the trolley being slidably along the length of the front rail; a box selectively positioned on the frame, the box including sides defining an upper opening and a lower opening; and a chute joined to the frame and adapted to be selectively connected to the box, the chute being selectively joined to the trolley.

### FIELD OF THE INVENTION

The present invention relates to bulk dispensers and particularly bulk grain dispensers mountable on the bed of a flatbed truck singly or in tandem and claims priority from provisional patent application No. 60/398,032, filed Jul. 23, 2003 and entitled BULK DISPENSER.

### BACKGROUND OF THE INVENTION

Material, commonly seeds or grain, are moved from location to location in bulk holders. At location, the material may be discharged with an auger, conveyor, air lock or other system perhaps to a planter. Various large equipment has been developed in this regard, generally complete machines. While useful in operation, these specialized machines are expensive and have no use when not moving grain, or other bulk material.

Farmers of modern times face many economic challenges from a variety of directions. Equipment that is useful only a small percentage of the time, such as existing bulk dischargers are not economically feasible. The equipment is expensive when incorporated into a vehicle. Moreover, additional storage space, under roof, is needed to protect the expensive equipment. Minimal use, no matter how necessary, impinges on the farmers ability to commercially succeed when the cost is high.

These pieces of equipment are also dangerous. Typically, these machines require the farmer to climb up onto the discharger for various operational activities. Fields, even when plowed, are rough, soft, e.g., not firm, and the ground is commonly moist. Footing is not stable and wet shoes decrease the sureness of footing. Thus, climbing up and down on equipment in the field is a dangerous activity that results in numerous injuries.

What is needed is a bulk discharger that is mountable on existing equipment, such as a flatbed truck, that a farmer may use for a variety of purposes. The bulk discharger should be operable from ground level, eliminating the need for climbing on dangerous equipment. Moreover, the bulk material discharger should be connectable to other bulk material dischargers such that the auger, air lock, conveyor or other such equipment can slide between each respective chute without the need for disassembly.

### DESCRIPTION OF THE DRAWINGS

FIG. 1 is a side view of the present invention shown mounted on a flatbed;

FIG. 2 is a front view of the present invention, which may be in tandem or homogeneously contiguous;

FIG. 3 is a top view of the frame of the present invention;

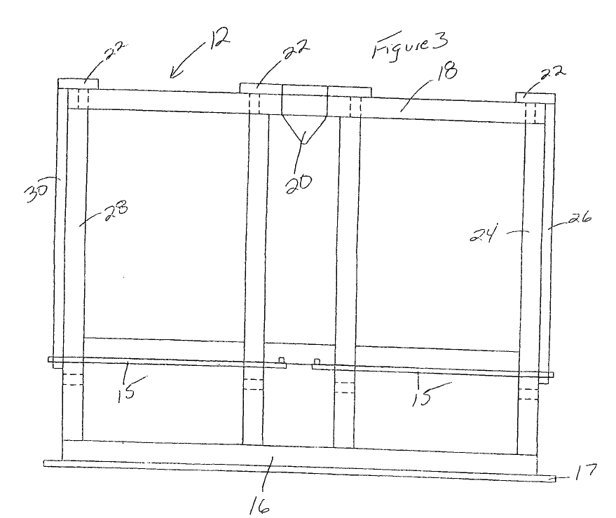

FIG. 4 is a side view of the chute and frame of the present invention;

FIG. 5 is a back view of a flatbed with a series of bulk material dispensers mounted thereon, showing the chutes joining in the center of the flatbed into a common chute; and

FIG. 6 is a side view of the flatbed in FIG. 5, showing the common chute joined to the material moving device.

### SUMMARY OF THE INVENTION

The present invention is a bulk discharger that is mountable on existing equipment, such as a flatbed truck, that a farmer may use for a variety of purposes. The bulk discharger is entirely operable from ground level, eliminating the need for climbing on dangerous equipment, since the trolley and chute are located on the frame, which is positioned below the box. Moreover, the bulk material discharger is connectable to other bulk material dischargers such that the auger, air lock, conveyor or other such equipment can slide between each respective chute without the need for disassembly.

The bulk dispenser may include a frame, a trolley, a box and a chute communicating contents of the box to the trolley. The frame may include legs interconnected with a front rail, a rear rail, a right side rail and a left side rail. The rear rail preferably is joined to an alignment wedge and at least one back lock down lip. The trolley may be joined to material moving device, suitable for moving the material previously contained in the box. The trolley is joined to the frame and is slidable along the length of the front rail. The box may be selectively positioned on the frame. The box includes sides defining an upper opening and a lower opening. The chute preferably is joined to the frame and adapted to be selectively connected to the box. The chute may further be selectively joined to the trolley.

In a preferred embodiment, two frames with two boxes may be joined in tandem. The trolley may contiguously slide along the length the front rails of both frames to operate with either box. Such configuration allows the equipment to be made sufficiently small to be liftable off a flatbed truck yet utilize the full capacity of the flatbed truck.

Advantageously, the present invention provides for a bulk material container which is portable and supportable on a flatbed truck.

Also an advantage, the present invention provides a bulk material dispenser which is connectable to similar bulk material dispensers such that the material moving device is usable with any of the material dispensers.

As yet a further advantage, the chute is suspended in such a manner as to avoid damage to the chute when the box is being removed from the frame.

As still yet a further invention, the trolley is structure with a flange that adjustably allows for connection to the chute regardless of the angle of the chute relative to the frame.

A further advantage is that the auger, air lock, conveyor or other related equipment together with the chute is operable by one while standing on the ground, since the trolley and chute are joined to the frame, which is positioned below the box.

Still yet another advantage, the chute is movable out of the way, which allows easier placement of the box (leaving plenty of room for operator error), side loading of the box onto the frame and allowance of the frame to align the box, whereas prior designs require precise placement to avoid damage to the chute or box.

These and other advantages will become clear from reading the appended description with reference to the drawings.

### DETAILED DESCRIPTION

The present invention 10 is a bulk goods dispenser for dispensing a variety of materials 80 such as grain. The dispenser 10 may include a frame 12, a box 50, a chute 70 and a trolley 90. The dispenser 10 may be positioned atop a flatbed 40.

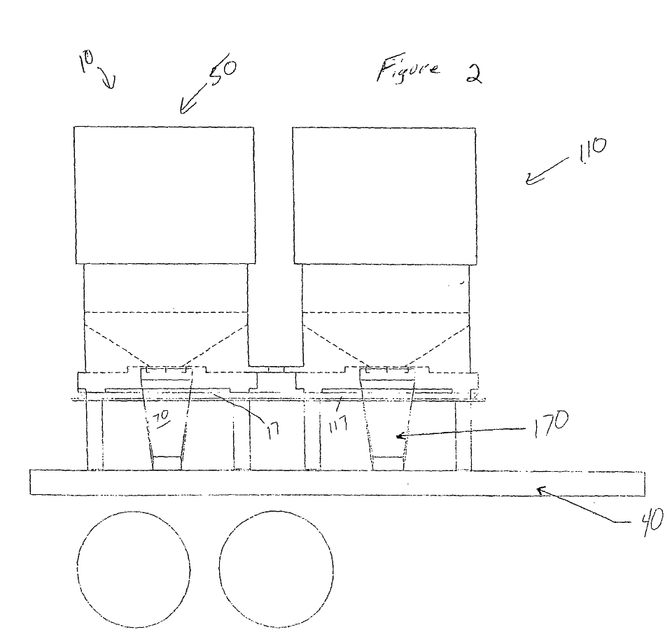

The frame 12 is to be of sufficient strength to support the box 50 when filled with grain 80, of sufficient breadth to support the box 50, and of sufficient height to provide clearance for the chute 70. The frame 12 may include legs 14, a front rail 16, a rear rail 18, a right side rail 24 and a left side rail 28. All rails 16, 18, 24, and 28 may be interconnect and joined to other supports if desired for strength or ease of mounting of the box 50. The frame 12 may hold one box 50 with multiple frames 12 placed side-by-side or the frame 12 may hold multiple boxes as shown in FIG. 2.

The rear rail 18 may have an alignment wedge 20 for alignment of the box 50. The alignment wedge 20 may be in a variety of locations, sizes and shapes, such that it communicates with the box 50 (not shown) perhaps in a lock and key type of arrangement. The rear rail 18 may further include at least one back lock down lip 22. The lip 22 allows a portion, e.g., edge, of the box to slide thereunder to limit the movement of the box 50. A front lock down 15 may be a selectively lockable swing arm that holds the front the box 50 to the frame 12.

The right side rail 24 and left side rail 28 may include guides 26 and 30 respectively to guide the box 50 being installed on the frame 12. Lips, such as back lock down lips 22 may be integral with guides 26 to further limit a properly positioned box 50. That is, an edge 51 of the box 50 may be positioned under the lip. Right and left, as terms referring to the sides, are used herein for descriptive purpose only and are not intended to be limiting of the invention. Generally, the designations right, left front and rear are relative to the user operating the present invention 10.

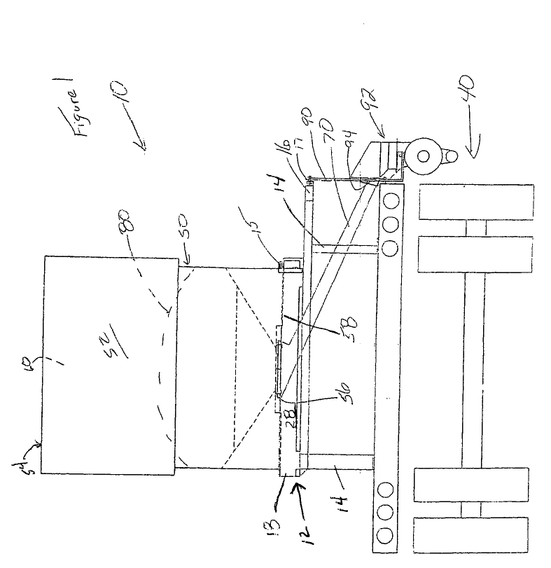

The trolley 90 may be joined to a material moving device 92, such as an air lock, an auger, a conveyer or other equipment used to fill a planter or other seeding device. The material moving device 92 is commonly sold in the industry such as the air lock through Christianson Systems, Inc. P.O. Box 138, Blomkest, Minn. 56216, http://www.christianson.com or manufacturers of similar equipment. The trolley 90 is in slidable engagement with the frame 12 and may in particular be joined to the front rail 16. Front rail 16 may have a U-shaped channel 17 as shown in FIG. 1, wherein the trolley 90 may ride. The trolley 90 may have a flange 94 sized and positioned to engage the chute 70, when the chute 70 is positioned to dispense grain or other material 80. Trolley 90 disengages the chute 70, when the chute 70 is disengaged from the box 50 via partial vertical rotation. The trolley 90 may then be slid or rolled along the front rail 16 away from the chute 70. The trolley 90 may be repositioned with respect to the chute 170 of an adjacent dispenser 110 as shown in FIG. 2, all without the need for the user to climb on the vehicle, by sliding the trolley 90 along U-shaped channel 17 to the selectively adjoining u-shaped channel 117.

The bottom 58 of the box 50 selectively joins to the frame 12 engaging the side rails 24 and 28, and the alignment wedge 20 and back lock down lips 22 of the rear rail 18. The box 50 includes sides 52, which define an upper opening 54 and lower opening 56. The interior 60 of the box 50 may be funnel shaped as shown to direct the grain 80 to the chute 70. A suitable box 50 may be obtained from Buckhorn, Inc. 55 West TechneCenter Drive, Milfrod Ohio 45150. Such box 50 is provided with a slide gate to control flow of the contents of the box 50.

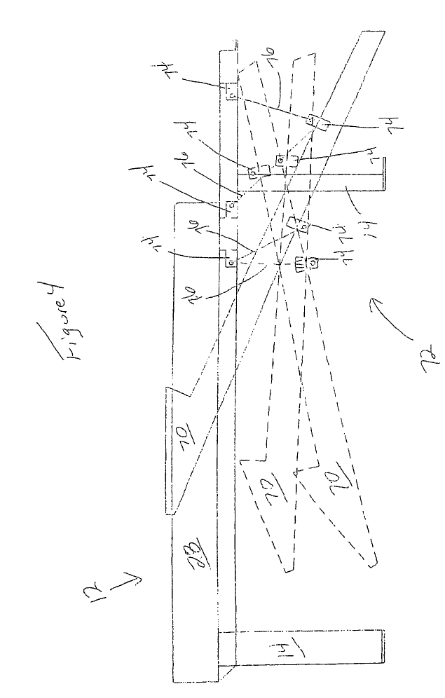

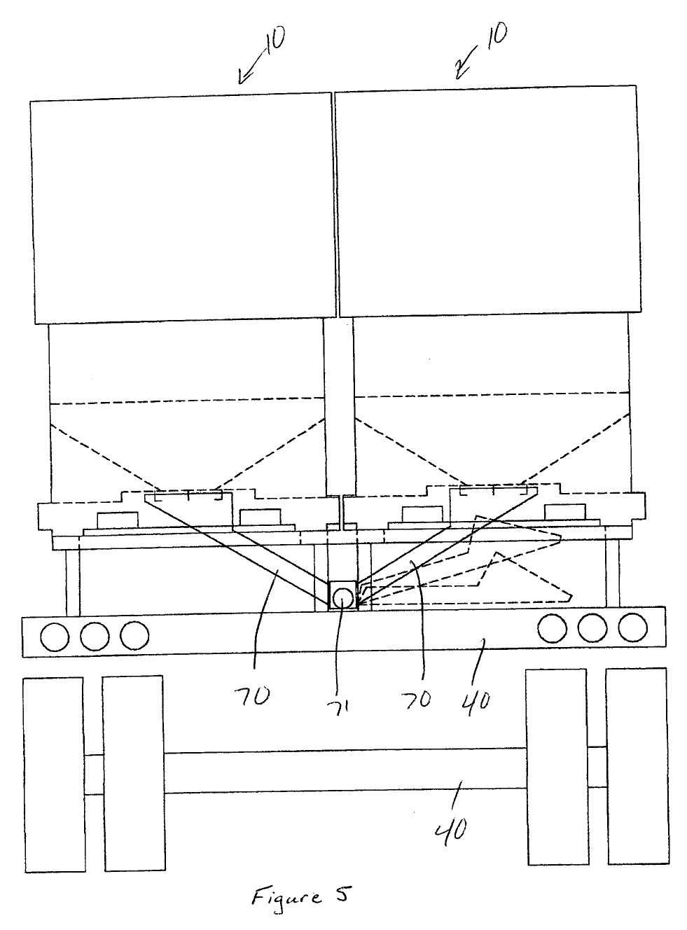

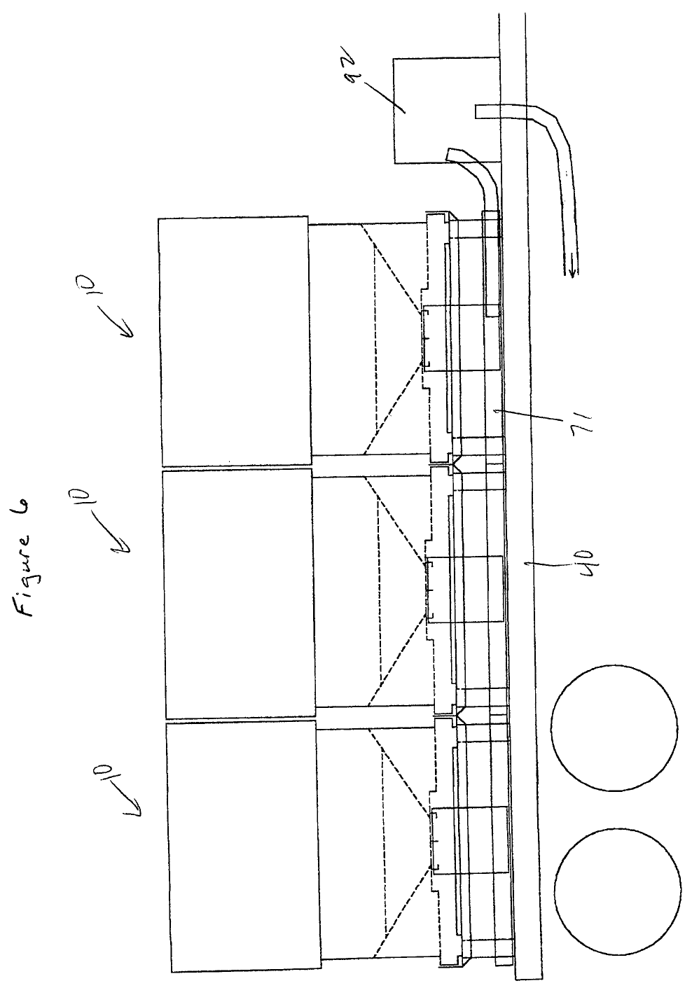

The chute 70 may be joined to the frame 12 and adapted to be selectively connected to the box 50. The chute 70, so positioned, with or without a common chute 71, may be accessed from above the bed 40 and delivers grain 80 to any desired part of the bed 40, including the center (as shown in FIGS. 5 and 6), edges or other part of the bed 40. The chute 70 may further be selectively joined to the trolley 90. As shown in FIG. 4, the suspension system 72 includes attachments 74 on the chute 70 and frame 12 joined by connectors 76. The attachments 74 may be flat iron, while the connectors 76 may be iron lengths pivotally joined with bolts to the attachments 74. Such joinder allows selective toggling of the chute 70 toward and away from the box 50 as shown in FIG. 4. The chute 70 is generally toggled to allow the box 50 to be slid off the frame 12 instead of the box 50 being lifted directly upward to avoid damage to the chute 70.

The dispenser 10 is designed to be placed on a flatbed 40 when in use. The dispenser 10 may be placed side-by-side with like dispensers as shown in FIG. 2, allowing full utilization of the space on the flatbed 40. To this end, it is desired that the front rail 16 and more particularly the U-shaped channel 17 extend sufficiently far to engage similar components on the neighboring frame 12, allowing the trolley 90 and associated material moving device 92 to be moved between the plurality of chutes 70.

In operation, at least one frame 12 may be mounted to a flatbed 40. The box 50 may be slid onto the frame 12, using the lock down lips 22, alignment guide 20, guides 26, 30 and front lock down 15. The trolley 90 may be positioned relative to the chute 70. Chute 70 may be tilted in the suspension system 72 to engage the lower opening 56 of the box 50 and the flange 94 of the trolley 90. Grain or other material 80 may then be placed into the box 50 through upper opening 54. Grain 80 may then be removed via the chute 70 and out through the material moving device 92.

Although the present invention has been described with reference to preferred embodiments, workers skilled in the art will recognize changes may be made in form and detail without departing from the spirit and scope of the invention.

1) A bulk dispenser, comprising:
a frame including legs interconnected with a front rail, rear rail, a right side rail and a left side rail, the rear rail joined to an alignment wedge and at least one back lock down lip;
a trolley joined to material moving device and joined to the frame, the trolley being slidably along the length of the front rail;
a box selectively positioned on the frame, the box including sides defining an upper opening and a lower opening; and
a chute joined to the frame and adapted to be selectively connected to the box, the chute being selectively joined to the trolley.

2) The bulk dispenser of claim 1 further comprising:
a flatbed, the frame being positioned on top of the flatbed.

3) The bulk dispenser of claim 1 wherein the a chute is selectively disengagable from the frame.

4) The bulk dispenser of claim 1 further comprising:
a front lock down positioned and structured to lock the box to the frame.

5) The bulk dispenser of claim 1 wherein the rear rail includes plurality of alignment wedges, the alignment wedges engaging with the box.

6) The bulk dispenser of claim 1 wherein the rear rail includes a back lock down lip structured to secure the box to the frame.

7) The bulk dispenser of claim 1 wherein the right side rail includes a guide structured to secure the box to the frame.

8) The bulk dispenser of claim 1 wherein the left side rail includes a guide structured to secure the box to the frame.

9) The bulk dispenser of claim 1 wherein the box has a funnel-shaped bottom.

10) The bulk dispenser of claim 1 wherein the chute is joined to the frame with a suspension system.

11) The bulk dispenser of claim 1 wherein the trolley includes a flange, the flange selectively joining the chute to the trolley.

12) The bulk dispenser of claim 1 wherein the trolley is joined to a material moving device.

13) The bulk dispenser of claim 12 wherein the material moving device is at least one member selected from the group consisting of air locks, augers, and conveyors.

14) The bulk dispenser of claim 1 comprising:
a second frame and a second box, the first and second frames being joined such that the trolley is movable between the first and second frames.

15) The bulk dispenser of claim 1 further including a U-shaped track joined to the front rail, the trolley being joined to the U-shaped track.

16) A bulk dispenser, comprising:
a first frame including legs interconnected with a front rail, rear rail, a right side rail and a left side rail;
a second frame including legs interconnected with a front rail, rear rail, a right side rail and a left side rail;
a flatbed, the first frame and the second frame being positioned on top of the flatbed;
a trolley selectively joined to the first frame and to the second frame, the trolley being contiguously slidably along the length of the front rails of the first frame and the second frame;
a first box selectively positioned on the first frame, the first box including sides defining an upper opening and a lower opening;
a second box selectively positioned on the second frame, the second box including sides defining an upper opening and a lower opening;
a first chute joined to the first frame and adapted to be selectively connected to the first box, the first chute being selectively joined to the trolley; and
a second chute joined to the second frame and adapted to be selectively connected to the second box, the second chute being selectively joined to the trolley.

17) The bulk dispenser of claim 16 further including a U-shaped track joined to the front rail of the first frame and the U-shaped track being joined to the front rail of the second frame, the trolley being joined to the U-shaped track.

18) The bulk dispenser of claim 16 wherein the trolley is joined to a material moving device.

19) The bulk dispenser of claim 18 wherein the material moving device is at least one member selected from the group consisting of air locks, augers, and conveyors.

20) 1) A bulk dispenser, comprising:
a first frame including legs interconnected with a front rail, rear rail, a right side rail and a left side rail, the rear rail joined to an alignment wedge and at least one back lock down lip;
a second frame including legs interconnected with a front rail, rear rail, a right side rail and a left side rail, the rear rail joined to an alignment wedge and at least one back lock down lip;
a trolley selectively joined to material moving device and joined to the first frame and to the second frame, the trolley being contiguously slidably along the length of the front rail of the first frame and the front rail of the second frame;
a first box selectively positioned on the first frame, the first box including sides defining an upper opening and a lower opening;
a second box selectively positioned on the second frame, the second box including sides defining an upper opening and a lower opening;
a first chute joined to the first frame and adapted to be selectively connected to the first box, the first chute being selectively joined to the trolley; and
a second chute joined to the second frame and adapted to be selectively connected to the second box, the second chute being selectively joined to the trolley.
